(19) United States
(12) Patent Application Publication
(10) Pub. No.: US 2005/0028849 A1
(43) Pub. Date: Feb. 10, 2005

(54) Vehicular washer nozzle and vehicular washer device having diffusion regulating structure

(75) Inventors: Tsuneo Fukushima, Kariya-city (JP); Tomohide Kawaguchi, Kosai-city (JP)

Correspondence Address: POSZ & BETHARDS, PLC, 11250 ROGER BACON DRIVE, SUITE 10, RESTON, VA, 20190, US

(73) Assignee: ASMO CO., LTD.

(21) Appl. No.: 10/911,588

(22) Filed: Aug. 5, 2004

(30) Foreign Application Priority Data
Aug. 8, 2003 (JP) 2003-289758

(51) Int. Cl. B08B 3/02

(52) U.S. Cl. 134/198; 239/284.1; 134/115 R; 134/181; 15/250.001

(57) ABSTRACT

A diffusion restriction portion is provided to a washer nozzle of a washer device to be opened outside along a direction, in which diffusive flow of cleansing liquid causing self-oscillation is jetted as a sector-shaped diffusive flow in its widthwise direction of the vehicle. Besides, the jetted diffusive flow is restricted in diffusion in its vertical direction by the diffusion restriction portion to be regulated. The washer nozzle is arranged on a back surface side of a rear end edge of an engine hood of a vehicle, and wiper arms are arranged lengthwise along the widthwise direction of the vehicle when being in a stopped position. Even in this case, the jetted diffusive flow can be sprinkled over a wide range in the widthwise direction of the vehicle. Besides, the diffusive flow can be sprinkled on a target sprinkle point from a narrow gap between the wiper arms and the rear end edge of the engine hood without interference.

### CROSS REFERENCE TO RELATED APPLICATION

This application is based on and incorporates herein by reference Japanese Patent Application No. 2003-289758 filed on Aug. 8, 2003.

### FIELD OF THE INVENTION

The present invention relates to a vehicular washer nozzle that jets cleansing liquid to wash a windshield of a vehicle, and a vehicular washer device that is provided with a washer nozzle to wash a windshield of a vehicle.

### BACKGROUND OF THE INVENTION

A washer device according to JP-A-10-236283 is constructed such that pressure-fed cleansing liquid is jetted toward a windshield. The washer nozzle is fixed to project above an engine hood of a vehicle, so that an outward appearance is degraded in terms of vehicular design. In addition, a vehicle body gets dirt when the cleansing liquid remaining in a hose drips from the washer nozzle.

In order to remedy a disadvantage of the washer device (washer nozzle) shown in JP-A-10-236283, another structure is proposed in JP-A-2000-344062, in which a washer nozzle is provided on an underside of a rear portion of an engine hood of a vehicle,

However, in the washer device (washer nozzle) shown in JP-A-2000-344062, wiper arms are arranged lengthwise along a widthwise direction of the vehicle, when a wiper device is stopped (in a stopped position) and a rear end edge of the engine hood comes out. Accordingly, when cleansing liquid is jetted toward a windshield from the washer nozzle, the jetted cleansing liquid may interfere with the wiper arms and the rear end edge of the engine hood, and scattered wastefully.

In particular, when a diffusion jet nozzle is adopted in order to supply cleansing liquid to a wide range of a windshield, the jetted cleansing liquid may be scattered. Here, the diffusion jet nozzle makes use of a fluid element (nozzle tip) to feed back a part of diffusive flow to cause self-oscillation of the same as a control flow, whereby a flow is jetted from the washer nozzle as diffusive flow spreading in a widthwise direction of the vehicle. That is, diffusive flow jetted from such a diffusion jet nozzle is not concentrated like jet flow, but water droplets of a small particle size are spread and jetted in the widthwise direction of the vehicle. The diffusive flow is also spread in a heightwise direction of the vehicle. Accordingly, it is difficult to sprinkle the diffusion jet flow on a desired sprinkle point from a narrow gap between the wiper arms and the rear end edge of the engine hood without interference.

### SUMMARY OF THE INVENTION

In view of the foregoing problems, it is an object of the present invention to provide a vehicular washer nozzle (vehicular washer devices) capable of sprinkling a diffused jet flow over a wide range in a widthwise direction of the vehicle and furthermore sprinkling the diffused jet flow on a target sprinkle point from a narrow gap between wiper arms and a rear end edge of an engine hood without interference.

According to the present invention, a vehicular washer device has a washer nozzle arranged on a back surface side of a rear end edge of an engine hood of a vehicle to jet pressure-fed cleansing liquid toward a windshield. The vehicular washer nozzle includes a nozzle body, a nozzle tip, a diffusion restriction portion, and a mount opening. The nozzle body is fixed to the vehicle, and formed with a feed passage through which the pressure-fed cleansing liquid is guided and fed. The nozzle tip is integrally assembled fluid-tightly to a receiving portion formed in the nozzle body. The nozzle tip defines an oscillation chamber and a diffusive jet port. The oscillation chamber communicates to the feed passage to cause self-oscillation of the cleansing liquid fed from the feed passage. The diffusive jet port communicates to the oscillation chamber to jet the cleansing liquid as a diffusive flow diffused in a widthwise direction of the vehicle. The diffusion restriction portion is provided on the nozzle body to outwardly open along a direction, in which a diffusive flow is jetted from the diffusive jet port. The diffusion restriction portion restricts and regulates the diffusive flow jetted from the diffusive jet port in a vertical direction of the vehicle, when the nozzle tip is assembled to the receiving portion of the nozzle body. The mount opening communicates to the receiving portion of the nozzle body and opens in a different direction than one direction, in which the diffusion restriction portion opens. The nozzle tip is assembled to the receiving portion through the mount opening.

### BRIEF DESCRIPTION OF THE DRAWINGS

The above and other objects, features and advantages of the present invention will become more apparent from the following detailed description made with reference to the accompanying drawings. In the drawings:

FIG. 1 is a partially cross sectional side view showing an entire structure of a washer nozzle and a washer device according to a first embodiment of the present invention;

FIG. 2 is a partially cross sectional side view showing the structure of the washer nozzle according to the first embodiment;

FIG. 3 is a perspective view showing the structure of a nozzle tip of the washer nozzle according to the first embodiment;

FIG. 4 is a rear view showing the structure of the nozzle tip of the washer nozzle according to the first embodiment;

FIG. 5 is a perspective view showing wiper arms of a wiper device according to an embodiment of the present invention;

FIG. 6 is a cross sectional side view showing another example of a nozzle body of the washer nozzle according to the first embodiment;

FIG. 7 is a partially cross sectional side view showing the structure of a washer nozzle according to a second embodiment of the present invention;

FIG. 8 is a partially cross sectional side view showing the structure of a washer nozzle according to a third embodiment of the present invention;

FIG. 9 is a perspective view showing a structure of the washer nozzle according to the third embodiment;

FIG. 10 is a partially cross sectional side view showing a structure of a washer nozzle according to a fourth embodiment of the present invention;

FIG. 11 is a partially cross sectional side view showing a structure of a washer nozzle according to a fifth embodiment of the present invention;

FIG. 12 is a perspective view showing the structure of a nozzle tip of a washer nozzle according to a sixth embodiment of the present invention;

FIG. 13 is a front view showing a wind shield and a washer nozzle according to the sixth embodiment;

FIG. 14 is a front view showing a wind shield and washer nozzles according to the sixth embodiment; and

FIG. 15 is a perspective view showing wiping area and the wiper arms according to the sixth embodiment.

### DETAILED DESCRIPTION OF PREFERRED EMBODIMENTS

(First Embodiment)

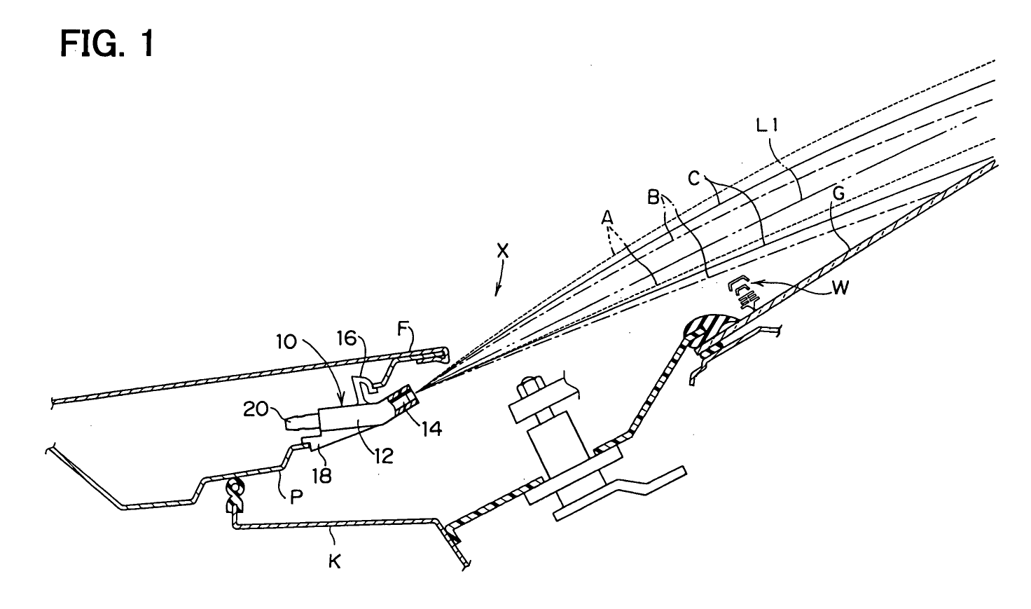

As shown in FIG. 1, a washer device X includes a washer nozzle 10 that has a nozzle body 12 and a nozzle tip 14. The nozzle body 12 is made of a resinous material, and formed on the upper surface side thereof with an elastic latch piece 16 and on the lower surface side thereof with a latch pawl 18. The elastic latch piece 16 and the latch pawl 18 are fitted into a back-side panel P on a rear end edge of an engine hood F of a vehicle to fix and arrange the nozzle body 12. A cylindrical-shaped hose connection 20 is formed at a rear end of the nozzle body 12 to be connected with a hose 22 that is connected to cleansing liquid containing tank (not shown).

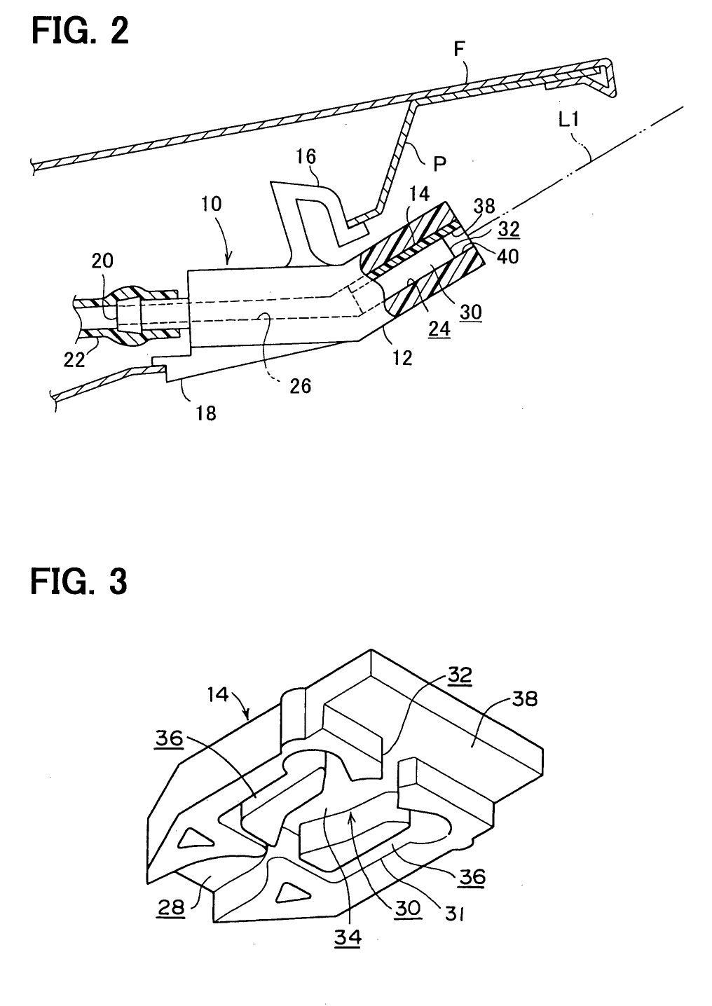

As shown in FIG. 2, the nozzle body 12 is formed with a tip receiving portion 24 that is opened to a front surface side (a side of a windshield G in FIGS. 1 and 2) of the nozzle body 12. A feed passage 26 is formed contiguous to the tip receiving portion 24 of the nozzle body 12. One end of the feed passage 26 extends to the hose connection 20.

The nozzle tip 14 formed by resin molding is integrally and fluid-tightly fitted into the tip receiving portion 24 of the nozzle body 12. As shown in detail in FIG. 3, the nozzle tip 14 is formed to be substantially box-shaped, and inserted into the tip receiving portion 24 of the nozzle body 12 from a front opened side thereof to be assembled thereto. The nozzle tip 14 is formed with a flow passage 28 (forming a part of the feed passage 26) that is communicated to the feed passage 26 in a state of being fitted into the tip receiving portion 24 of the nozzle body 12. Further, an oscillation chamber 30 and a diffusive jet port 32 are formed on the lower side (lower side in FIGS. 1 to 3) of the nozzle tip 14.

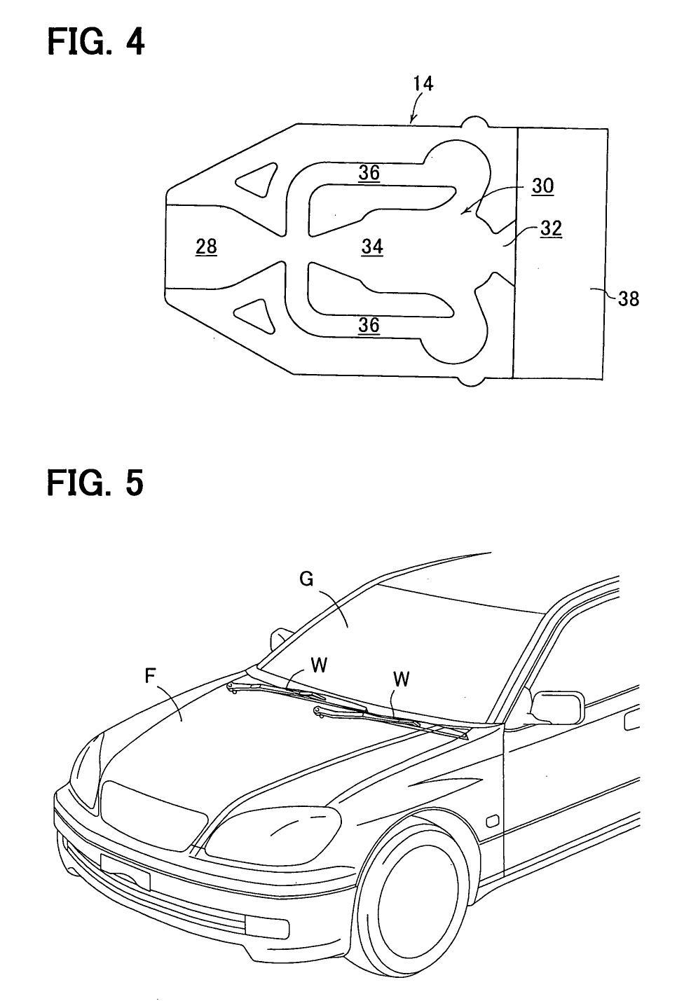

As shown in detail in FIG. 4, the oscillation chamber 30 is formed with a main flow passage 34, which is contiguous to the flow passage 28 and communicated to the diffusive jet port 32, and a pair of feedback flow passages 36 that substantially horizontally branch left and right from the main flow passage 34. Cleansing liquid is supplied to the oscillation chamber 30 from the flow passage 28. The feedback flow passages 36 are formed such that a part of the cleansing liquid fed from the flow passage 28 is divided and guided at this time to be returned to the main flow passage 34. Thereby, the cleansing liquid guided to the feedback flow passages 36 makes a “control flow” to cause self-oscillation of the cleansing liquid flowing in the main flow passage 34. The cleansing liquid causing the self-oscillation is jetted as a sector-shaped diffusive flow from the diffusive jet port 32. Accordingly, the cleansing liquid can be jetted over a comparatively wide range in a widthwise direction of the vehicle to increase an area being cleansed.

The nozzle tip 14 is formed with an upper correction plate portion 38 that serves as a diffusion restriction portion. The upper correction plate portion 38 is integrally formed to extend from immediately above the diffusive jet port 32, i.e., a bottom wall portion opposed to an opening surface 31 of the oscillation chamber 30. The upper correction plate portion 38 is provided along a jet direction of diffusive flow jetted from the diffusive jet port 32. Thereby, when the nozzle tip 14 is assembled to the tip receiving portion 24 of the nozzle body 12, the upper correction plate portion 38 is opposed immediately backwardly of the diffusive jet port 32 to an opening lower wall surface 40 (FIG. 2) in a front opened portion of the tip receiving portion 24 of the nozzle body 12. The flat-shaped upper correction plate portion 38 and the opening lower wall surface 40, which extend continuously over the nozzle tip 14 in its widthwise direction, form the diffusion restriction portion.

That is, when the nozzle tip 14 is assembled to the tip receiving portion 24 of the nozzle body 12, the diffusion restriction portion formed by the upper correction plate portion 38 and the opening lower wall surface 40 is opened outside along a target jet direction L1 of the diffusive flow jetted from the diffusive jet port 32. The upper correction plate portion 38 restricts and regulates an upward diffusion of diffusive flow jetted from the diffusive jet port 32, and the opening lower wall surface 40 restricts and regulates a downward diffusion of diffusive flow jetted from the diffusive jet port 32. That is, the upper correction plate portion 38 of the nozzle tip 14 and the opening lower wall surface 40 of the tip receiving portion 24 of the nozzle body 12 cooperate together to restrict and regulate diffusion of diffusive flow jetted from the diffusive jet port 32, in the vertical direction of the vehicle. The vertical direction of the vehicle is perpendicular to a direction of diffusion.

Besides, in this case, the target jet direction L1 of the diffusive flow, which is regulated by the upper correction plate portion 38 and the opening lower wall surface 40, becomes coincident (coaxial) with a direction, in which the nozzle tip 14 is inserted into and assembled to the tip receiving portion 24 of the nozzle body 12. That is, the target jet direction L1 of the diffusive flow becomes parallel to the bottom wall surface of the oscillation chamber 30.

As described above, with the washer nozzle 10, the diffusive jet port 32 is a “fluidics type nozzle”. Cleansing liquid is jetted as diffusive flow from the diffusive jet port 32, and the diffusion restriction portion formed by the upper correction plate portion 38 and the opening lower wall surface 40 restricts and regulates a vertical diffusion of the diffusive flow to enable diffusively jetting the diffusive flow.

Next, an operation of the first embodiment will be described.

In the washer device X, to which the washer nozzle 10 constructed in the manner described above is applied, the washer nozzle 10 is arranged on a back surface side of a rear end edge of the engine hood F of a vehicle.

Cleansing liquid pressure-fed from the tank passes through the hose connection 20 and the feed passage 26 of the nozzle body 12, and flows into the oscillation chamber 30 of the nozzle tip 14 after passing through the flow passage 28. At this time, a part of the cleansing liquid fed from the flow passage 28 is divided by the feedback flow passages 36 to be returned to the main flow passage 34. Thereby, the cleansing liquid guided to the feedback flow passages 36 makes a control flow to cause self-oscillation of the cleansing liquid flowing in the main flow passage 34. The cleansing liquid occurring self-oscillation becomes water droplets of a small particle size to be jetted as a sector-shaped diffusive flow in the widthwise direction of the vehicle from the diffusive jet port 32.

Here, with the washer nozzle 10, when the nozzle tip 14 is assembled to the tip receiving portion 24 of the nozzle body 12, the diffusion restriction portion is opened outside along the jet direction of diffusive flow jetted from the diffusive jet port 32. The diffusive flow jetted from the diffusive jet port 32 is restricted in diffusion in the vertical direction of the vehicle by the upper correction plate portion 38 and the opening lower wall surface 40 to be regulated. The vertical direction of the vehicle is the direction perpendicular to the direction of diffusion of the cleansing liquid. Here, the diffusion restriction portion is constructed with the upper correction plate portion 38 of the nozzle tip 14 and the opening lower wall surface 40 of the tip receiving portion 24 of the nozzle body 12.

Accordingly, even when the washer nozzle 10 is arranged on the back surface side of the rear end edge of the engine hood F of a vehicle, and wiper arms W in its stopped position are arranged lengthwise along the widthwise direction of the vehicle as shown in FIG. 5, the diffusive flow jetted from the diffusive jet port 32 can be sprinkled over a wide range in the widthwise direction of the vehicle. Besides, the diffusive flow can be sprinkled on a target sprinkle point of the windshield G from a narrow gap between the wiper arms W and the rear end edge of the engine hood F as shown by broken lines A, alternate long and short dash lines B, and solid lines C in FIG. 1 without interference.

As shown in FIG. 1, a jet range indicated by the broken lines A defines an upper limit range. A jet range indicated by the alternate long and short dash lines B defines a lower limit range. A jet range indicated by the solid lines C defines a target jet range, and the straight line L1 indicates a target jet direction, in which sprinkling in the target jet range is performed.

Also, since the washer nozzle 10 is arranged on the back surface side of the rear end edge of the engine hood F of a vehicle, surfaces of a vehicle body do not get dirt even when cleansing liquid remaining in the hose 22 drips, for example. Here, the hose 22 supplies cleansing liquid. Besides, a vehicle is improved in design quality.

Further, with the washer nozzle 10, the oscillation chamber 30 having a complex shape relative to the diffusive jet port 32 is formed to be opened to an underside of the nozzle tip 14. Besides, the upper correction plate portion 38 constructing the diffusion restriction portion is integrally formed to extend from the bottom wall portion of the nozzle tip 14 opposed to the opening surface 31 of the oscillation chamber 30. Therefore, the upper correction plate portion 38 may be in a simple shape, in which the bottom wall portion of the nozzle tip 14 is extended in a manner like a pent roof. Accordingly, when the nozzle tip 14 is molded from a resinous material, a molding die can be in a simple shape.

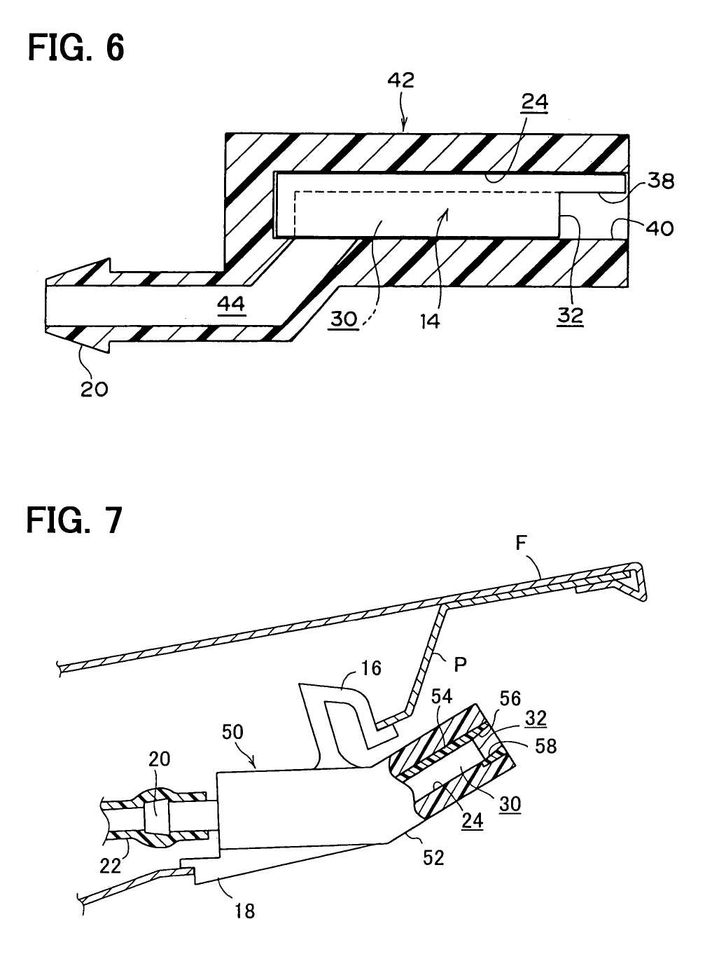

The feed passage 26 of the nozzle body 12 is formed to be communicated linearly to the flow passage 28 of the nozzle tip 14, in this embodiment. However, a feed passage 44 may be communicated to an underside of the oscillation chamber 30 of the nozzle tip 14 in a washer nozzle 42 shown in FIG. 6.

(Second Embodiment)

As shown in FIG. 7, a washer nozzle 50 has a nozzle body 52 and a nozzle tip 54. The nozzle body 52 has the substantially same structure as that of the nozzle body 12 of the washer nozzle 10 described in the first embodiment, and accommodates a nozzle tip 54 in a tip receiving portion 24 thereof.

On the contrary, similarly to the nozzle tip 14 of the washer nozzle 10 described in the first embodiment, the nozzle tip 54 is formed with an oscillation chamber 30 and a diffusive jet port 32 on the underside (lower side in FIG. 7) thereof.

Further, the nozzle tip 54 is formed with an upper correction plate portion 56 and a lower correction plate portion 58, which form a diffusion restriction portion. Similarly to the upper correction plate portion 38 of the washer nozzle 10 described in the first embodiment, the upper correction plate portion 56 forming the diffusion restriction portion is integrally formed to extend from immediately above a diffusive jet port 32. That is, the upper correction plate portion 56 is integrally formed to extend from a bottom wall portion opposed to an opening surface 31 of the oscillation chamber 30, and provided along a jet direction of diffusive flow jetted from the diffusive jet port 32. On the contrary, the lower correction plate portion 58 forming the diffusion restriction portion is integrally formed to extend from immediately below the diffusive jet port 32. That is, the lower correction plate portion 58 is integrally formed to extend from a wall portion on a side of the opening surface 31 of the oscillation chamber 30, and provided along the jet direction of diffusive flow jetted from the diffusive jet port 32. Thereby, the upper correction plate portion 56 and the lower correction plate portion 58 face each other in a parallel state immediately backwardly of the diffusive jet port 32. The upper correction plate portion 56 and the lower correction plate portion 58 form the diffusion restriction portion.

That is, the diffusion restriction portion formed with the upper correction plate portion 56 and the lower correction plate portion 58 is provided to be opened outside along the jet direction of diffusive flow jetted from the diffusive jet port 32. The upper correction plate portion 56 restricts and regulates an upward diffusion of diffusive flow jetted from the diffusive jet port 32, and the lower correction plate portion 58 restricts and regulates an downward diffusion of diffusive flow jetted from the diffusive jet port 32. That is, the upper correction plate portion 56 and the lower correction plate portion 58 of the nozzle tip 54 cooperate together to restrict and regulate diffusion, in the vertical direction of the vehicle, of diffusive flow jetted from the diffusive jet port 32.

Besides, in this case, the upper correction plate portion 56 and the lower correction plate portion 58 are inclined upward at a predetermined angle relative to a direction, in which the nozzle tip 54 is inserted into and assembled to the tip receiving portion 24 of the nozzle body 12. That is, an axis of a regulated diffusive flow in its jet direction is directed upward at a predetermined angle relative to the bottom wall surface of the oscillation chamber 30. Therefore, target jet can be set in the vertical direction of the vehicle, which is different from the direction, in which the nozzle tip 54 is inserted into and assembled to the tip receiving portion 24 of the nozzle body 12.

As described above, with the washer nozzle 50, the diffusive jet port 32 has a structure of a “fluidics type nozzle”. Thus, cleansing liquid is jetted as diffusive flow from the diffusive jet port 32. Besides, the diffusion restriction portion formed by the upper correction plate portion 56 and the lower correction plate portion 58 of the nozzle tip 54 restricts and regulates diffusion of the diffusive flow in the vertical direction of the vehicle to enable diffusively jetting the diffusive flow.

Next, an operation of the second embodiment will be described.

With the washer nozzle 50, the diffusion restriction portion is formed by the upper correction plate portion 56 and the lower correction plate portion 58, which are formed to extend integrally from the nozzle tip 54. Accordingly, the diffusion restriction portion can be formed by only the nozzle tip 54 without depending on the nozzle body 52. Therefore, the nozzle body 52 can be commonly used for different nozzle tips 54. Besides, an action of regulation, in which diffusion of diffusive flow in the vertical direction of the vehicle is restricted by the upper correction plate portion 56 and the lower correction plate portion 58. Furthermore, a jet angle (direction) can be set with high accuracy without being affected by the assembling accuracy of the nozzle tip 54. Here, the vertical direction of the vehicle is perpendicular to the direction of diffusion.

Further, with the washer nozzle 50, the upper correction plate portion 56 and the lower correction plate portion 58 are provided to be inclined upward at a predetermined angle and an axis of a regulated diffusive flow in its jet direction is directed upward at a predetermined angle. Therefore, setting of a jet angle can be easily modified every vehicle or every type of vehicle by making a shape of the oscillation chamber 30 common for different nozzle tips 54, that is, by setting only the upper correction plate portion 56 and the lower correction plate portion 58 in a different manner. Here, the oscillation chamber 30 is a fundamental constituent portion (important constituent portion) of the nozzle tip 54.

In addition, in this embodiment, the upper correction plate portion 56 and the lower correction plate portion 58 face each other in a parallel state immediately backwardly of the diffusive jet port 32. However, the upper correction plate portion 56 and the lower correction plate portion 58 may be shaped vertically small, so that a passage is gradually made convergent in height toward a tip end side (side of the outside opening) from the diffusive jet port 32.

In this case, a vertical extent of a jetted diffusive flow can be further corrected, and jet pressure of diffusive flow jetted from the diffusive jet port 32 can be suitably raised, so that jet can be efficiently achieved.

(Third Embodiment)

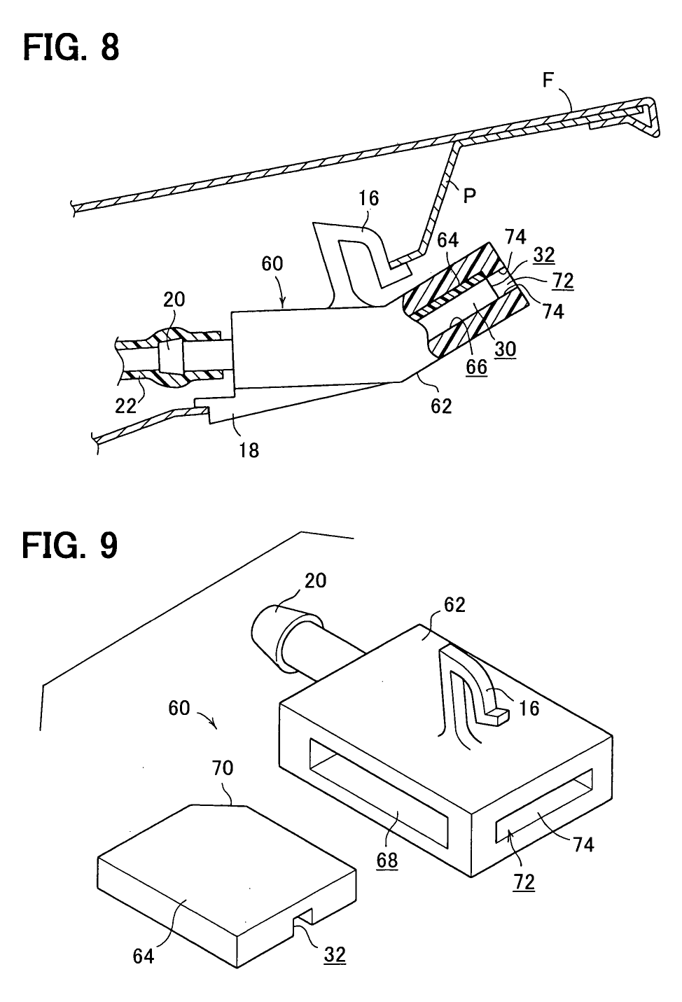

As shown in FIGS. 8 and 9, a washer nozzle 60 has a nozzle body 62 and a nozzle tip 64. The nozzle body 62 has a fundamentally the same structure as that of the nozzle body 12 of the washer nozzle 10 described in the first embodiment, and accommodates a nozzle tip 64 in a tip receiving portion 66.

The tip receiving portion 66 of the nozzle body 62 is opened to a right side (front side of the plane of FIG. 8) of the nozzle body 62, and the opening forms a mount opening 68, through which the nozzle tip 64 is assembled to the tip receiving portion 66 of the nozzle body 62.

On the other hand, the nozzle tip 64 has fundamentally the same structure as that of the nozzle tip 14 of the washer nozzle 10 according to the first embodiment, and the nozzle tip 64 is formed with an oscillation chamber 30 and a diffusive jet port 32. The nozzle tip 64 (FIG. 9) is provided in a corner on a rear end side thereof with a chamfer 70. When the nozzle tip 64 is assembled to the tip receiving portion 66 of the nozzle body 62 from the mount opening 68 of the nozzle body 62, the chamfer 70 serves as a confirmation portion of orientation of the nozzle tip 64 and can prevent the nozzle tip 64 from wrong assembling.

Also, a passage 72 is formed in a front part (right side in FIG. 8) of the nozzle body 62. The passage 72 is formed to be opened outside along a direction, in which diffusive flow from the diffusive jet port 32 is jetted, when the nozzle tip 64 is assembled to the tip receiving portion 66 of the nozzle body 62. Besides, upper and lower opening wall surface portions 74 of the passage 72 form a diffusion restriction portion. That is, when the nozzle tip 64 is assembled to the tip receiving portion 66 of the nozzle body 62, the pair of upper and lower opening wall surface portions 74, which form the diffusion restriction portion, extend contiguous to upper and lower end edges of the diffusive jet port 32, and face each other in a parallel state. The pair of upper and lower opening wall surface portions 74 extend along a direction, in which diffusive flow from the diffusive jet port 32 is jetted, to restrict and regulate diffusion of diffusive flow jetted from the diffusive jet port 32 in the vertical direction of the vehicle.

Besides, in this case, an axis of diffusive flow regulated by the pair of upper and lower opening wall surface portions 74 in its jet direction is made coincident (coaxial) with the bottom wall surface of the oscillation chamber 30 of the nozzle tip 64, when the nozzle tip 64 is assembled to the tip receiving portion 66 of the nozzle body 62.

Next, an operation of the third embodiment will be described.

With the washer nozzle 60 (washer device, to which the washer nozzle 60 is applied) constructed in the above manner, the washer nozzle 60 is arranged on a back surface side of a rear end edge of an engine hood F of a vehicle.

Cleansing liquid is pressure-fed from the tank into the oscillation chamber 30 of the nozzle tip 64 through a hose connection 20 of the nozzle body 62. At this time, a part of the cleansing liquid fed from a flow passage 28 is divided and guided by feedback flow passages 36 to be returned to a main flow passage 34. Thereby, the cleansing liquid guided to the feedback flow passages 36 makes a control flow to cause self-oscillation of the cleansing liquid flowing in the main flow passage 34. The cleansing liquid causing self-oscillation is made water droplets of a small particle size to be jetted as a sector-shaped diffusive flow in the widthwise direction of the vehicle from the diffusive jet port 32.

Here, with the washer nozzle 60, the pair of upper and lower opening wall surface portions 74 of the passage 72 are provided to extend contiguous to upper and lower end edges of the diffusive jet port 32 respectively, when the nozzle tip 64 is assembled to the tip receiving portion 66 of the nozzle body 62. That is, the pair of upper and lower opening wall surface portions 74 are provided to extend along a direction, in which diffusive flow is jetted from the diffusive jet port 32, and face each other parallelly. The diffusive flow jetted from the diffusive jet port 32 is restricted in diffusion in the vertical direction of the vehicle by the pair of upper and lower opening wall surface portions 74 to be regulated.

Accordingly, even when the washer nozzle 60 is arranged on the back surface side of the rear end edge of the engine hood F of a vehicle, and wiper arms W are arranged lengthwise along the widthwise direction of the vehicle as shown in FIG. 5 when being in a stopped position, diffusive flow jetted from the diffusive jet port 32 can be sprinkled over a wide range in the widthwise direction of the vehicle. Besides, the diffusive flow can be sprinkled on a target sprinkle point from a narrow gap between the wiper arms W and the rear end edge of the engine hood F without interference.

Further, with the washer nozzle 60, the diffusion restriction portion is formed by the pair of upper and lower opening wall surface portions 74 of the passage 72 formed in the nozzle body 62, so that the diffusion restriction portion can be formed by only the nozzle body 62 without depending on the nozzle tip 64. Therefore, that restriction (regulation) on diffusion of diffusive flow in the vertical direction, which is imposed by the pair of upper and lower opening wall surface portions 74, and a jet angle (direction) can be set with high accuracy without being affected by the assembling accuracy of the nozzle tip 64.

Besides, in this case, the nozzle body 62 is provided with the mount opening 68 that is opened in a different direction than one direction, in which the pair of upper and lower opening wall surface portions 74 (the passage 72) as the diffusion restriction portion are opened. The nozzle tip 64 is assembled to the tip receiving portion 66 of the nozzle body 62 from the mount opening 68. That is, the nozzle tip 64 is assembled to the nozzle body 62 from the mount opening 68 opened in a different direction than one direction, in which the opening wall surface portions 74 (the passage 72) are opened. Therefore, the nozzle tip 64 can be assembled to the tip receiving portion 66 of the nozzle body 62 without being affected by a shape of the pair of upper and lower opening wall surface portions 74 as the diffusion restriction portion. Thus, even when an angle, in which diffusion of diffusive flow in the vertical direction of the vehicle is restricted by the pair of upper and lower opening wall surface portions 74, and a jet angle (direction) are set differently, the nozzle tip 64 can be used in common, and such difference can be accommodated on a side of the nozzle body 62.

Also, since the washer nozzle 60 is arranged on the back surface side of the rear end edge of the engine hood F of a vehicle, surfaces of a vehicle body do not get dirt even when the cleansing liquid remaining in the hose 22 drips, for example. Besides, a vehicle is improved in design quality.

(Fourth Embodiment)

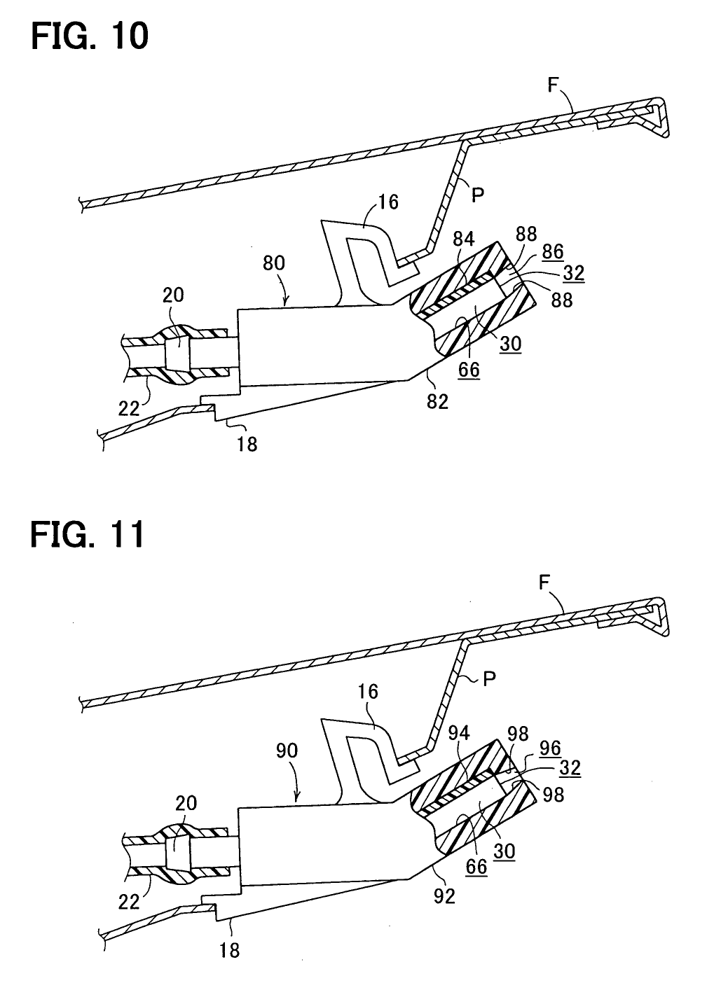

As shown in FIG. 10, a washer nozzle 80 has a nozzle body 82 and a nozzle tip 84. The nozzle body 82 has a substantially the same structure as that of the nozzle body 62 of the washer nozzle 60 described in the third embodiment, and accommodates a nozzle tip 84 in a tip receiving portion 66. The nozzle tip 84 has a substantially the same structure as that of the nozzle tip 64 of the washer nozzle 60 described in the third embodiment.

Further, a passage 86 is formed in a front part (right side in FIG. 10) of the nozzle body 82. The passage 86 is opened outside along a direction, in which diffusive flow from the diffusive jet port 32 is jetted, when the nozzle tip 84 is assembled to the tip receiving portion 66 of the nozzle body 62. Upper and lower opening wall surface portions 88 of the passage 86 form a diffusion restriction portion. That is, when the nozzle tip 84 is assembled to the tip receiving portion 66 of the nozzle body 62, the pair of upper and lower opening wall surface portions 88 that form the diffusion restriction portion extend contiguous to upper and lower end edges of the diffusive jet port 32. That is, the pair of upper and lower opening wall surface portions 88 extend along a direction, in which diffusive flow is jetted from the diffusive jet port 32, and face each other in a parallel state. Besides, the pair of upper and lower opening wall surface portions 88 restrict and regulate diffusion of diffusive flow jetted from the diffusive jet port 32 in the vertical direction of the vehicle.

Besides, in this case, the upper and lower opening wall surface portions 88 are inclined upward at a predetermined angle relative to a bottom wall surface of an oscillation chamber 30 of the nozzle tip 84 assembled to the tip receiving portion 66 of the nozzle body 62. That is, an axis of a regulated diffusive flow in its jet direction is directed upward at a predetermined angle.

Next, an operation of the fourth embodiment will be described.

With the washer nozzle 80, the diffusion restriction portion is formed by the pair of upper and lower opening wall surface portions 88 of the passage 86 formed in the nozzle body 82, so that the diffusion restriction portion can be formed by only the nozzle body 82 without depending on the nozzle tip 84. Therefore, that restriction (regulation) on diffusion of diffusive flow in the vertical direction of the vehicle, which is imposed by the pair of upper and lower opening wall surface portions 88, and a jet angle (direction) can be set with high accuracy without being affected by the assembling accuracy of the nozzle tip 84.

Further, with the washer nozzle 80, the pair of upper and lower opening wall surface portions 88 are provided to be inclined upward at a predetermined angle, and an axis of a regulated diffusive flow in its jet direction is directed upward at a predetermined angle. Therefore, setting of a jet angle can be easily modified every vehicle or every type of vehicle by making a shape of the oscillation chamber 30 common for different nozzle tips 84, that is, by setting only the pair of upper and lower opening wall surface portions 88 of the nozzle body 82 in a different manner. Here, the oscillation chamber 30 is a fundamental constituent portion (important constituent portion) of the nozzle tip 84.

(Fifth Embodiment)

As shown in FIG. 11, a washer nozzle 90 has a nozzle body 92 and a nozzle tip 94. The nozzle body 92 has substantially the same structure as that of the nozzle body 62 of the washer nozzle 60 described in the third embodiment, and accommodates a nozzle tip 94 in a tip receiving portion 66. The nozzle tip 94 has substantially the same structure as that of the nozzle tip 64 of the washer nozzle 60 described in the third embodiment.

Further, a passage 96 is formed in a front part (right side in FIG. 11) of the nozzle body 92. The passage 96 is opened outside along a direction, in which diffusive flow is jetted from the diffusive jet port 32, when the nozzle tip 94 is assembled to the tip receiving portion 66 of the nozzle body 62. Upper and lower opening wall surface portions 98 of the passage 96 form a diffusion restriction portion. That is, when the nozzle tip 94 is assembled to the tip receiving portion 66 of the nozzle body 62, the pair of upper and lower opening wall surface portions 98 that form the diffusion restriction portion extend contiguous to upper and lower end edges of the diffusive jet port 32. Namely, the pair of upper and lower opening wall surface portions 98 extend along a direction, in which diffusive flow from the diffusive jet port 32 is jetted, and face each other. Besides, the pair of upper and lower opening wall surface portions 98 restrict and regulate diffusion of diffusive flow jetted from the diffusive jet port 32 in the vertical direction of the vehicle.

Besides, in this case, the upper and lower opening wall surface portions 98 are shaped vertically small. Therefore, the passage 96 is gradually made convergent, i.e., narrow in height toward a tip end side (side of the outside opening) from the diffusive jet port 32 of the nozzle tip 94 assembled to the tip receiving portion 66 of the nozzle body 62.

Next, an operation of the fifth embodiment will be described.

With the washer nozzle 90, the diffusion restriction portion is formed by the pair of upper and lower opening wall surface portions 98 of the passage 96 formed in the nozzle body 92, so that the diffusion restriction portion can be formed by only the nozzle body 92 without depending on the nozzle tip 94. Therefore, that restriction (regulation) on diffusion of diffusive flow in the vertical direction of the vehicle, which is imposed by the pair of upper and lower opening wall surface portions 98, and a jet angle (direction) can be set with high accuracy without being affected by the assembling accuracy of the nozzle tip 94.

Further, with the washer nozzle 90, the pair of upper and lower opening wall surface portions 98 are shaped vertically small. Therefore, the passage 96 is gradually made convergent, i.e., narrow in height (spacing between the pair of upper and lower opening wall surface portions 98) toward a tip end side (side of the outside opening), so that a vertical extent of a jetted diffusive flow can be further corrected. Thus, jet pressure of diffusive flow jetted from the diffusive jet port 32 can be suitably raised, so that jet can be efficiently formed.

(Sixth Embodiment)

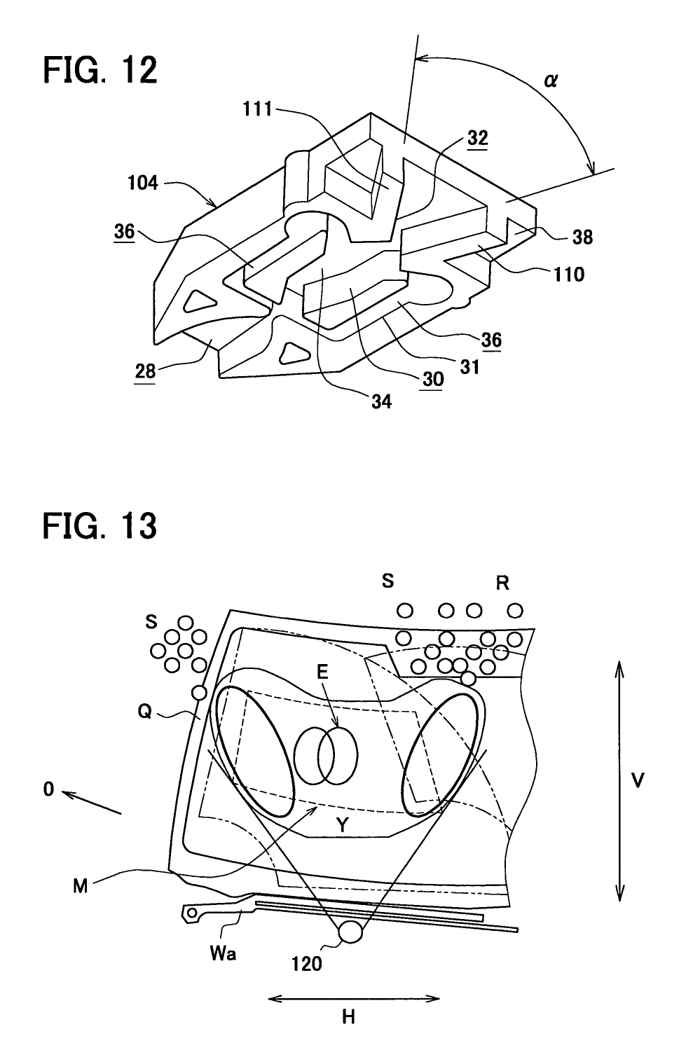

As shown in FIG. 12, in the sixth embodiment, a nozzle tip 104 has a horizontal diffusion restriction portion formed by a first wall portion 110 and a second wall portion 111, in addition to the diffusion restriction portion (vertical diffusion restriction portion) described in the first to fifth embodiments. The horizontal diffusion restriction portion outwardly opens from the diffusive jet port 32 to uniformize a fan angle α, in which diffused flow of cleansing liquid is splayed. The nozzle tip 104 is assembled to a tip receiving portion of a nozzle body, which has the same structure as that of the first to fifth embodiments.

In the above structure of the washer nozzle described in the first to fifth embodiments, diffusive flow jetted from the washer nozzle is restricted and regulated in diffusion in the vertical direction of the vehicle. Therefore, as shown in FIG. 13, an amount of splay out S of the diffusive flow can be reduced in the vertical direction V of the vehicle, so that a roof R of the vehicle can be restricted from getting dirt due to sprinkling cleansing liquid. However, in this structure, the diffusive flow is not regulated in the horizontal direction H of the vehicle, and the diffusive flow may be horizontally splayed out of the front pillars (A pillars) Q. As a result, the diffusive flow may be partially sprinkled outside O of the wind shield G of the vehicle. Besides, the diffusive flow is not a convergent flow in the width direction H, and diffusive flow may not be effectively sprinkled on the target sprinkle point Y Accordingly, an eye range E may not be preferably secured.

On the contrary, in the sixth embodiment, the nozzle tip 104 has the horizontal diffusion restriction portion formed by the first wall portion 110 and the second wall portion 111, so that dispersion of the fan angle α, in which the diffused flow is splayed, can be reduced. Therefore, an amount of splay out S, which is diffused in the width direction H and splayed out of the front pillars Q of the vehicle, can be reduced. Therefore, diffusion of diffusive flow is regulated and restricted in the horizontal direction H of the vehicle, and main flow M of the diffusive flow can be sprinkled on the target sprinkle point Y, so that the eye range E can be preferably secured by convergence of the diffusive flow of cleansing liquid. Thus, the diffusive flow is restricted and regulated in both the width direction H and the height direction V of the vehicle by the horizontal diffusion restriction portion and the vertical diffusion restriction portion. Accordingly, the diffusive flow of the cleansing liquid can be sprinkled, while splay out S is reduced in both the width direction H and the vertical direction V and interference relevant to the wiper arms W and the rear end edge of the engine hood F is also reduced.

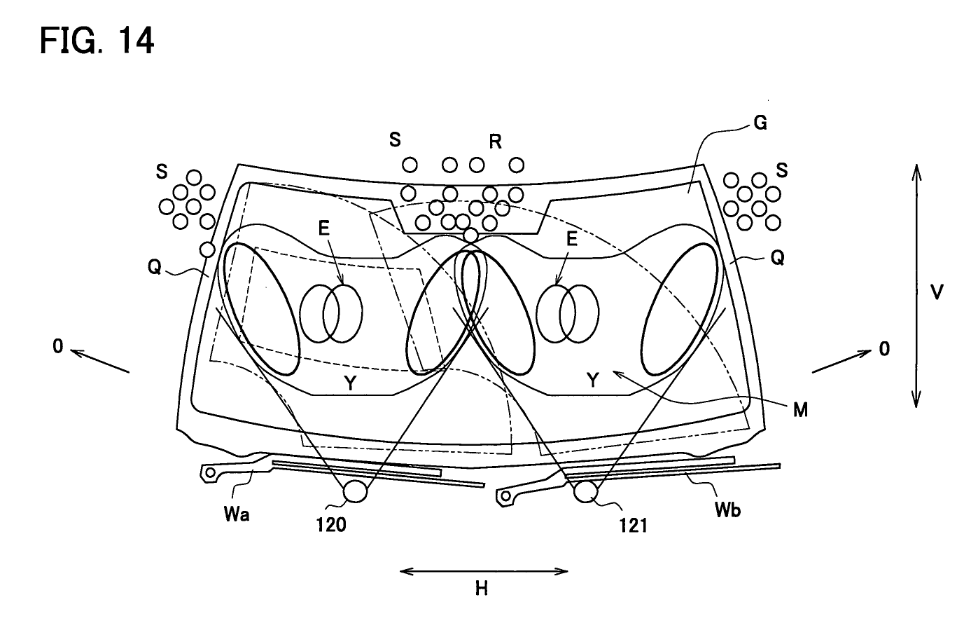

As shown in FIG. 14, multiple washer nozzles 120, 121 can be provided to the vehicle. Specifically, a first washer nozzle (driver washer nozzle) 120 and a second washer nozzle (passenger washer nozzle) 121 are individually provided to be apart from each other in the horizontal direction H of the vehicle. The first washer nozzle 120 and the second washer nozzle 121 respectively have the horizontal diffusion restriction portion formed by the first wall portion 110 and the second wall portion 111. Thus, the diffusive flow of the cleansing liquid can be respectively sprinkled on target sprinkle points Y from the first washer nozzle 120 and the second washer nozzle 121, while splay out S in the width direction H is reduced. Therefore, eye ranges E can be further preferably secured.

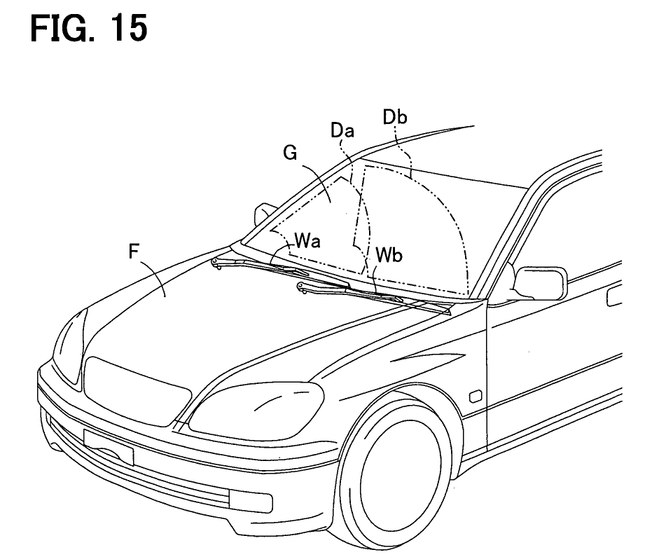

As shown in FIG. 15, a first wiper Wa and a second wiper Wb are provided to the vehicle to wipe the windshield G. The first wiper (driver seat side wiper) Wa wipes a first wiping area Da of the windshield, which is located in front of a driver seat, and the second wiper (passenger seat side wiper) Wb wipes a second wiping area Db of the windshield G, which is located in front of a front passenger seat. The first wiper Wa and the second wiper Wb are synchronized with each other, and the wiping areas Da, Db are simultaneously wiped. In the sixth embodiment, a washer device X can include the first washer nozzle 120 and the second washer nozzle 121 to individually diffuse cleansing liquid toward the first wiping area Da and the second wiping area Db of the wind shield G.

The respective embodiments are described with respect to a structure, in which the washer nozzle 10, 42, 50, 60, 80, 90, 120, 121, or the like is mounted to the back-side panel P on the rear end edge of the engine hood F of a vehicle. However, the washer nozzle may be mounted to a cowl panel (including a cowl top panel) K as long as the panel is disposed on a back surface side of the rear end edge of the engine hood F.

Various modifications and alternations may be made to the above embodiments without departing from the spirit of the present invention.

1. A vehicular washer nozzle arranged on a back surface side of a rear end edge of an engine hood of a vehicle to jet pressure-fed cleansing liquid toward a windshield, the vehicular washer nozzle comprising:
a nozzle body that is fixed to the vehicle and formed with a feed passage through which the pressure-fed cleansing liquid is guided and fed;
a nozzle tip that is integrally assembled fluid-tightly to a receiving portion formed in the nozzle body, such that the nozzle tip defines:
an oscillation chamber that communicates to the feed passage to cause self-oscillation of the cleansing liquid fed from the feed passage; and
a diffusive jet port that communicates to the oscillation chamber to jet the cleansing liquid as a diffusive flow diffused in a widthwise direction of the vehicle; and
a diffusion restriction portion that extends from the diffusive jet port along a direction in which a diffusive flow is jetted so that the diffusive restriction portion restricts and regulates the diffusive flow jetted from the diffusive jet port in a vertical direction of the vehicle.

2. The vehicular washer nozzle according to claim 1,
wherein the oscillation chamber opens to one of upper and lower surfaces of the nozzle tip, and
the diffusion restriction portion is defined by both an upper correction plate portion, which integrally extends from a bottom wall portion of the nozzle tip opposed to an opening surface of the oscillation chamber, and an opening lower wall surface of the nozzle body on a side of the opening surface of the oscillation chamber.

3. The vehicular washer nozzle according to claim 1,
wherein the oscillation chamber opens to one of upper and lower surfaces of the nozzle tip, and
the diffusion restriction portion has an upper correction plate portion, which extends integrally from a bottom wall portion of the nozzle tip opposed to an opening surface of the oscillation chamber, and a lower correction plate portion integrally extending from a wall portion of the nozzle tip on a side of the opening surface of the oscillation chamber.

4. A vehicular washer nozzle arranged on a back surface side of a rear end edge of an engine hood of a vehicle to jet pressure-fed cleansing liquid toward a windshield, the vehicular washer nozzle comprising:
a nozzle body that is fixed to the vehicle and formed with a feed passage through which the pressure-fed cleansing liquid is guided and fed;
a nozzle tip that is integrally assembled fluid-tightly to a receiving portion formed in the nozzle body, such that the nozzle tip defines:
an oscillation chamber that communicates to the feed passage to cause self-oscillation of the cleansing liquid fed from the feed passage; and
a diffusive jet port that communicates to the oscillation chamber to jet the cleansing liquid as a diffusive flow diffused in a widthwise direction of the vehicle;
a diffusion restriction portion that is formed in the nozzle body to extend from the diffusive jet port along a direction in which a diffusive flow is jetted so that the diffusion restriction portion restricts and regulates the diffusive flow jetted from the diffusive jet port in a vertical direction of the vehicle; and
a mount opening that communicates to the receiving portion of the nozzle body and opens in a different direction than one direction, in which the diffusion restriction portion opens,
wherein the nozzle tip is assembled to the receiving portion through the mount opening.

5. The vehicular washer nozzle according to claim 4,
wherein the diffusion restriction portion has a pair of opening wall surface portions extending contiguous to upper and lower end edges of the diffusive jet port, and
the opening wall surface portions are opposed with each other.

6. The vehicular washer nozzle according to claim 1, wherein the diffusion restriction portion is inclined at a predetermined angle with respect to a bottom wall surface of the oscillation chamber to set a predetermined direction, in which the diffusive flow is jetted.

7. The vehicular washer nozzle according to claim 1, wherein the diffusion restriction portion has a vertically small shape, which is gradually convergent in height toward the opening from the diffusive jet port.

8. A vehicular washer device comprising at least one washer nozzle arranged on a back surface side of a rear end edge of an engine hood of a vehicle to jet pressure-fed cleansing liquid toward a windshield using the washer nozzle, the washer nozzle including:
a nozzle body that is fixed to the vehicle and formed with a feed passage through which the pressure-fed cleansing liquid is guided and fed;
a nozzle tip that is integrally assembled fluid-tightly to a receiving portion formed in the nozzle body, such that the nozzle tip defines:
an oscillation chamber that communicates to the feed passage to cause self-oscillation of the cleansing liquid fed from the feed passage; and
a diffusive jet port that communicates to the oscillation chamber to jet the cleansing liquid as a diffusive flow diffused in a widthwise direction of the vehicle; and
a diffusion restriction portion that extends from the diffusive jet port along a direction in which a diffusive flow is jetted so that the diffusion restriction portion restricts and regulates the diffusive flow jetted from the diffusive jet port in a vertical direction of the vehicle.

9. A vehicular washer device comprising at least one washer nozzle arranged on a back surface side of a rear end edge of an engine hood of a vehicle to jet pressure-fed cleansing liquid toward a windshield using the washer nozzle, the washer nozzle including:
a nozzle body that is fixed to the vehicle and formed with a feed passage through which the pressure-fed cleansing liquid is guided and fed;
a nozzle tip that is integrally assembled fluid-tightly to a receiving portion formed in the nozzle body, such that the nozzle tip defines:
an oscillation chamber that communicates to the feed passage to cause self-oscillation of the cleansing liquid fed from the feed passage; and
a diffusive jet port that communicates to the oscillation chamber to jet the cleansing liquid as a diffusive flow diffused in a widthwise direction of the vehicle;
a diffusion restriction portion that is formed in the nozzle body to extend from the diffusive jet port along a direction in which a diffusive flow is jetted so that the diffusion restriction portion restricts and regulates the diffusive flow jetted from the diffusive jet port in a vertical direction of the vehicle; and
a mount opening that communicates to the receiving portion of the nozzle body and opens in a different direction than one direction, in which the diffusion restriction portion opens,
wherein the nozzle tip is assembled to the receiving portion through the mount opening.

10. The vehicular washer nozzle according to claim 1, wherein the feed passage is communicated to an underside of the oscillation chamber of the nozzle tip in the nozzle body.

11. The vehicular washer nozzle according to claim 1, wherein the nozzle tip has a horizontal diffusion restriction portion that extends from the diffusive jet port along the direction in which the diffusive flow is jetted so that the horizontal diffusion restriction portion restricts and regulates the diffusive flow jetted from the diffusive jet port in a horizontal direction of the vehicle.

12. The vehicular washer device according to claim 8, wherein the nozzle tip has a horizontal diffusion restriction portion that extends from the diffusive jet port along the direction in which the diffusive flow is jetted so that the horizontal diffusion restriction portion restricts and regulates the diffusive flow jetted from the diffusive jet port in a horizontal direction of the vehicle.

13. The vehicular washer device according to claim 12, further comprising:
a passenger washer nozzle that includes the nozzle tip having the horizontal diffusion restriction portion,
wherein the washer nozzle and the passenger washer nozzle are apart from each other by a predetermined distance in the width direction of the vehicle.

14. A vehicular washer device according to claim 13,
wherein the washer nozzle and the passenger washer nozzle respectively diffuse cleansing liquid toward a first wiping area and a second wiping area of a wind shield of the vehicle, and
the first wiping area and the second wiping area are respectively wiped by a first wiper and a second wiper that are synchronized with each other.
